(19) United States
(12) Patent Application Publication
(10) Pub. No.: US 2007/0280327 A1
(43) Pub. Date: Dec. 6, 2007

(54) Electrode joint

(76) Inventors: Robert E. Smith, Strongsvile, OH (US); Mark Segger, Strongsville, OH (US); James J. Pavlisin, Cleveland, OH (US); Michael Frastaci, Parma, OH (US); Brian Bowman, Westlake, OH (US); Terrence P. Wells, Strongsville, OH (US); Thomas W. Weber, Cleveland, OH (US); Lionel B. Batty, Westlake, OH (US); Philip D. Coleman, Avon, OH (US); Diane M. Artman, Westlake, OH (US)

Correspondence Address: WADDEY & PATTERSON, P.C., 1600 DIVISION STREET, SUITE 500, NASHVILLE, TN, 37203, US

(21) Appl. No.: 11/803,667

(22) Filed: May 15, 2007

Related U.S. Application Data
(63) Continuation-in-part of application No. 10/860,378, filed on Jun. 3, 2004, now Pat. No. 7,230,969.
(63) Continuation-in-part of application No. 11/405,351, filed on Apr. 17, 2006.
Application No. 11/405,351 is a continuation-in-part of application No. 10/760,947, filed on Jan. 20, 2004, now abandoned.
(63) Continuation-in-part of application No. 11/489,772, filed on Jul. 20, 2006.
Application No. 11/489,772 is a continuation of application No. 10/975,607, filed on Oct. 28, 2004, now Pat. No. 7,103,083.
Application No. 11/489,772 is a continuation-in-part of application No. 10/830,618, filed on Apr. 23, 2004, now Pat. No. 7,016,394.
(63) Continuation-in-part of application No. 11/024,372, filed on Dec. 28, 2004.

(51) Int. Cl. H05B 7/06

(52) U.S. Cl. 373/92

(57) ABSTRACT

An assembly with a threaded connection, including an outer part made from ceramic, having an axially tapered internal thread, and having a diameter A; an inner part made from ceramic, having an axially tapered external thread, and having an equator with a diameter B, the diameter B at the equator of the inner part amounting to between 80% and 110% of the diameter A of the outer part.

### RELATED APPLICATIONS

This application is a continuation-in-part of co-pending and commonly assigned U.S. patent application Ser. No. 10/860,378, filed Jun. 3, 2004, entitled “Electrode Joint Locking System,” the disclosure of which is incorporated herein by reference; and
the application is also a continuation in part of co-pending and commonly assigned U.S. patent application Ser. No. 11/405,351, filed Apr. 17, 2006, entitled Locking Ring For Graphite Electrodes,” which in turn is a continuation-in-part of co-pending and commonly assigned U.S. patent application Ser. No. 10/760,947, filed Jan. 20, 2004, entitled “End-Face Seal for Graphite Electrodes,” the disclosures of which are incorporated herein by reference; and
this application is also a continuation-in-part of co-pending and commonly assigned U.S. patent application Ser. No. 11/489,772, filed Jul. 20, 2006, entitled “Optimized Graphite Electrode Pin Configuration,” which in turn is a continuation of co-pending and commonly assigned U.S. patent application Ser. No. 10/975,607, filed Oct. 28, 2004, entitled “Optimized Graphite Electrode Pin Configuration,” now U.S. Pat. No. 7,103,083, and a continuation-in-part of co-pending and commonly assigned U.S. patent application Ser. No. 10/830,618, filed Apr. 23, 2004, entitled “Male-Female Electrode Joint,” now U.S. Pat. No. 7,016,394, the disclosures of each of which are incorporated herein by reference;
and this application is also a continuation-in-part of co-pending and commonly assigned U.S. patent application Ser. No. 11/024,372, filed Dec. 28, 2004, entitled “Extended Length Graphite Electrode,” the disclosure of which is incorporated herein by reference.

### BACKGROUND OF THE INVENTION

1. Technical Field

The present invention relates to a joint for graphite electrodes, and especially one which includes a threaded male tang used to join graphite electrodes. More particularly, in one embodiment, the invention concerns a unique design for a male-female electrode joint, and the electrodes from which the joint is formed; in another embodiment, the invention concerns the configuration of pins used to join graphite electrodes into an electrode column. The invention also encompasses an end-face seal or locking ring for graphite electrodes, especially for large diameter graphite electrodes.

2. Background Art

Graphite electrodes are used in the steel industry to melt the metals and other ingredients used to form steel in electrothermal furnaces. The heat needed to melt metals is generated by passing current through a plurality of electrodes, usually three, and forming an arc between the electrodes and the metal. Electrical currents in excess of 100,000 amperes are often used. The resulting high temperature melts the metals and other ingredients. Generally, the electrodes used in steel furnaces are each used in electrode columns, that is, a series of individual electrodes joined to form a single column. In this way, as electrodes are depleted during the thermal process, replacement electrodes can be joined to the column to maintain the length of the column extending into the furnace.

Conventionally, electrodes are joined into columns via a pin (sometimes referred to as a nipple) that functions to join the ends of adjoining electrodes. Typically, the pin takes the form of opposed male threaded sections, with at least one end of the electrodes comprising female threaded sections capable of mating with the male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint.

Of course, the optimal way of achieving thermal compatibility between pin and electrodes is to form the pin of the same material from which the electrodes are formed; however, in conventional pin joints, the pin must be formed of a graphite material that is stronger than the material from which the electrodes are formed needs to be. If the pin is not formed of a stronger material, it would fail (i.e., suffer cracks and breakage) to an unacceptable degree while in use in an electrode column. In order to avoid this, the pin can be formed, e.g., of a graphite material of a higher density than that needed for the electrodes.

Alternatively, the electrodes can be formed with a male threaded protrusion or tang machined into one end and a female threaded socket machined into the other end, such that the electrodes can be joined by threading the male tang of one electrode into the female socket of a second electrode, and thus form an electrode column. The joined ends of two adjoining electrodes in such an embodiment is also referred to in the art as a joint or, more specifically, a male-female joint.

As a consequence, if the pin can be eliminated from the electrode/electrode column system, the need to balance the thermal expansion of the different system components (i.e., pin and electrode) is reduced. Prior attempts to eliminate the pin have been attempted, where a threaded electrode end or other electrode mating means have been employed. Industry acceptance has lagged, however, since it is felt that the strength of the joint is not sufficient to maintain the integrity of the electrode column without a pin.

Whether a pin is employed, or male-female electrodes employed, the unique environment of an electric arc furnace creates issues for the design and utilization of graphite electrodes. More particularly, given the extreme thermal stress that the electrode and the joint (and indeed the electrode column as a whole) undergoes, mechanical/thermal factors such as strength, thermal expansion, and crack resistance must be carefully balanced to avoid damage or destruction of the electrode column or individual electrodes. For instance, longitudinal (i.e., along the length of the electrode/electrode column) thermal expansion of the electrodes, especially at a rate different than that of the pin, can force the joint apart, reducing effectiveness of the electrode column in conducting the electrical current. A certain amount of transverse (i.e., across the diameter of the electrode/electrode column) thermal expansion of the electrode in excess of that of the pin may be desirable to form a firm connection between pin and electrode; however, if the transverse thermal expansion of the electrode greatly exceeds that of the pin, damage to the electrode or separation of the joint may result. Again, this can result in reduced effectiveness of the electrode column, or even destruction of the column if the damage is so severe that the electrode column fails at the joint section.

In the production of a male-female electrode joint, so-called “blocked” threads are often employed. In blocked threads, both thread flanks from one of the elements (such as the male tang) is in contact with both thread flanks from the other element (such as the female socket), as illustrated in FIG. 8A. Contrariwise, in “non-blocked” or “unblocked” threads, only one thread flank from each element contacts the threads of the other element, as illustrated in FIG. 8B.

Moreover, another effect of the thermal and mechanical stresses to which an electrode column is exposed is literal unscrewing of the electrodes forming the joint (or the electrodes and pins forming the joint), due to vibrations and other stresses. This unscrewing can reduce electrode column efficiency by reducing electrical contact between adjoining electrodes. In the most severe case, unscrewing can result in loss of the electrode column below the affected joint.

What is desired, therefore, is an electrode joint configured to have sufficient strength and integrity to reduce column damage in use and create a more stable joint and to withstand the forces to which it will be exposed, and especially to permit elimination of the pin, without a significant reduction in electrode performance. What is also desired is a seal or locking ring for reducing oxidation at the surfaces portions of graphite electrode joints and for inhibiting the potential for unscrewing of the joint. It is also highly desirable to achieve these property benefits without using high quantities of expensive materials.

### SUMMARY OF THE INVENTION

It is an aspect of the present invention to provide a joint for graphite electrodes which is designed to better withstand the thermal and mechanical stress on an electrode column in use.

It is yet another aspect of the present invention to provide a pin for graphite electrodes which produces electrode column joints having improved strength and stability.

Still another aspect of the present invention is a graphite electrode joint, having improved resistance to stub loss, defined as the loss of the part of the electrode column lying from the arc tip to and sometimes including the joint closest to the arc tip, as compared to art-conventional graphite electrode joints.

It is another aspect of the present invention to provide a male-female joint for graphite electrodes.

It is still another aspect of the present invention to provide a male-female joint for graphite electrodes which is designed to better withstand the thermal and mechanical stress on an electrode column in use, as compared to prior male-female graphite electrode joints.

It is yet another aspect of the present invention to provide a male-female joint for graphite electrodes which produces electrode column joints having improved strength and stability.

It is an aspect of the present invention to provide a seal or locking ring for the end faces of graphite electrodes.

It is another aspect of the present invention to provide a locking ring for the end faces of graphite electrodes which reduces or eliminates the tendency of electrode joints to come unscrewed.

It is yet another aspect of the present invention to provide a locking ring for the end faces of graphite electrodes which produces electrode column joints having improved strength and stability.

These aspects and others that will become apparent to the artisan upon review of the following description can be accomplished by providing a pin for an electrode joint having opposed male tangs, or a graphite electrode for use in a male-female electrode joint, the electrode having a male tang, where the ratio of male tang length to diameter of the electrode of at least about 0.60. In a preferred embodiment of the application, the ratio of the diameter of the male tang to the length of the male tang should be no more than about 2.5 times the ratio of the length of the male tang to the diameter of the electrode when the ratio of the length of the male tang to the electrode diameter is about 0.60 or higher. Indeed, the ratio of the diameter of the male tang at its base to the male tang length should vary with the ratio of male tang length to electrode diameter such that for every 0.01 higher than 0.60 the ratio of male tang length to electrode diameter is, the ratio of the diameter of the male tang at its base to the male tang length should be about 0.016 lower than 1.5.

The inventive pin or graphite electrode, when having a ratio of male tang length to electrode diameter of 0.85 or lower, should preferably also have a ratio of the taper of the male tang, expressed in degrees, to the ratio of male tang length to electrode diameter of at least about 15. Moreover, the ratio of the taper of the male tang to the ratio of male tang length to electrode diameter varies with the ratio of male tang length to electrode diameter such that for every 0.01 lower than 0.85 the ratio of male tang length to electrode diameter is, the ratio of the taper of the male tang to the ratio of male tang length to electrode diameter should be about 1.25 higher than 15.

The invention also includes an electrode joint formed from the inventive pin or graphite electrode, and a second graphite electrode having a female threaded socket, wherein the male threaded tang engages the female threaded socket to form the joint.

Additionally, the present invention encompasses providing an electrode joint, either a pin joint or a male-female joint, comprising two joined graphite electrodes and having a seal (sometimes referred to herein as a locking ring) interposed between the end faces of the electrodes, the seal comprising a compressible material, especially compressed particles of exfoliated graphite. The seal can be provided as a plurality of individual elements for ease of transport/storage. The seal material preferably comprises material having an oxidation rate equivalent to or less than that of the electrodes. In an especially preferred embodiment, the electrical conductivity of the seal is greater in the direction extending between the electrodes than it is in the direction orthogonal thereto. In order to accomplish this, the seal should advantageously comprise a spiral wound sheet of compressed particles of exfoliated graphite.

To form the inventive seal, sheets of compressed particles of exfoliated graphite are overlaid, preferably with the use of an adhesive therebetween, and then trimmed to the desired size and shape if necessary. The seal should have an outer diameter generally equal to the outer diameter of the electrode joint and an inner opening which is at least the diameter of the male tang (whether formed in the end of an electrode or as part of a pin) to be employed.

Alternatively, to form the inventive seal, one or more sheets of compressed particles of exfoliated graphite is provided and then wound (for instance around a bolster having a diameter equal to the inner opening of the seal) to form a spiral wound seal suitable for use between the electrodes in an electrode joint. The seal should have an outer diameter generally equal to the outer diameter of the electrode joint and an inner opening, and can but does not necessarily have an adhesive interposed between the layers of the spiral wound sheet of compressed particles of exfoliated graphite.

Stated alternatively, the invention includes an assembly with a threaded connection, comprising an outer part made from ceramic (such as synthetically produced carbon or graphite), having an axially tapered internal thread, and having a diameter A; an inner part made from ceramic, having an axially tapered external thread, and having an equator with a diameter B, and; said diameter B at said equator of said inner part amounting to between 80% and 110% of said diameter A of said outer part.

More specifically, the outer part is a carbon or graphite electrode with a socket and said internal thread formed therein, and the inner part is a carbon or graphite pin or nipple with an external thread formed to mesh with the internal thread for connecting two electrodes. The internal and external threads advantageously enclose a taper angle E with a centerline of the inner and outer parts, respectively, of 18 to 35 degrees. The internal and external threads preferably have a lead D of a conventional 2 to 4 threads per inch. Moreover, the inner part has an axial length C, and a ratio of the axial length C to the diameter B is from 0.5 to 2.0.

The outer parts and the inner part are configured and dimensioned to preclude end-face contact between said outer parts, wherein the internal threads and the external threads are fully engaged and conduct electrical current flowing between the outer parts to pass through the inner part but not through the end faces of the outer parts.

The invention also encompasses an electrode column, comprising a plurality of the above-described assemblies, wherein the inner part is a pin screwing the electrodes together to form the electrode column, and wherein the assembly forms a load-bearing connection that is substantially not susceptible to unscrewing and cracking.

In addition, the invention encompasses an assembly with a threaded connection, comprising carbon electrodes having a machined threaded male surface at one end thereof and a threaded female surface at an opposite end thereof configured to receive a corresponding male end from an adjoining electrode, wherein the male and female surfaces are configured with geometrical design parameters that preclude end-face contact between mutually adjoining electrodes, and said threads of said male and female surfaces are fully engaged to force all electrical current to pass therethrough and not through end faces of said electrodes.

It is to be understood that both the foregoing general description and the following detailed description provide embodiments of the invention and are intended to provide an overview or framework of understanding to nature and character of the invention as it is claimed. The accompanying drawings are included to provide a further understanding of the invention and are incorporated in and constitute a part of the specification. The drawings illustrate various embodiments of the invention and together with the description serve to describe the principles and operations of the invention.

### BRIEF DESCRIPTION OF THE DRAWINGS

FIG. 1 is a partial side cross-sectional view of a male-female graphite electrode joint in accordance with the present invention.

FIG. 2 is a partial side cross-sectional view of a graphite electrode having a male tang for the male-female graphite electrode joint of FIG. 1.

FIG. 3 is a partial side cross-sectional view of a female socket for the male-female graphite electrode joint of FIG. 1.

FIG. 4 is a side plan view of a pin in accordance with the present invention.

FIG. 5 is a partial side broken-away view of a graphite electrode joint employing the pin of FIG. 4.

FIG. 6 is a partial side cross-sectional view of opposing graphite electrodes, each having a female socket for the pin of FIG. 4.

FIG. 7 is a side perspective view of an end-face seal for a graphite electrode in accordance with the present invention.

FIG. 8 is a side perspective view of a spiral wound flexible graphite structure from which the end-face seal of FIG. 7 is derived.

FIG. 9 is a partial side cross-sectional view of a male threaded graphite electrode having an end-face seal in accordance with the present invention thereon.

FIG. 10 is a partial side cross-sectional view of a graphite electrode having a pin threaded thereinto and having an end-face seal in accordance with the present invention thereon.

FIG. 11 is a side plan view of an electrode joint having an end-face seal in accordance with the present invention therein.

### DETAILED DESCRIPTION OF THE PREFERRED EMBODIMENT

Graphite electrodes can be fabricated by first combining a particulate fraction comprising calcined coke, pitch and, optionally, mesophase pitch or PAN-based carbon fibers into a stock blend. More specifically, crushed, sized and milled calcined petroleum coke is mixed with a coal-tar pitch binder to form the blend. The particle size of the calcined coke is selected according to the end use of the article, and is within the skill in the art. Generally, in graphite electrodes for use in processing steel, particles up to about 25 millimeters (mm) in average diameter are employed in the blend. The particulate fraction preferable includes a small particle size filler comprising coke powder. Other additives that may be incorporated into the small particle size filler include iron oxides to inhibit puffing (caused by release of sulfur from its bond with carbon inside the coke particles), coke powder and oils or other lubricants to facilitate extrusion of the blend.

After the blend of particulate fraction, pitch binder, etc. is prepared, the body is formed (or shaped) by extrusion though a die or molded in conventional forming molds to form what is referred to as a green stock. The forming, whether through extrusion or molding, is conducted at a temperature close to the softening point of the pitch, usually about 100° C. or higher. The die or mold can form the article in substantially final form and size, although machining of the finished article is usually needed, at the very least to provide structure such as threads. The size of the green stock can vary; for electrodes the diameter can vary between about 220 mm and 700 mm.

After extrusion, the green stock is heat treated by baking at a temperature of between about 700° C. and about 1100° C., more preferably between about 800° C. and about 1000° C., to carbonize the pitch binder to solid pitch coke, to give the article permanency of form, high mechanical strength, good thermal conductivity, and comparatively low electrical resistance, and thus form a carbonized stock. The green stock is baked in the relative absence of air to avoid oxidation. Baking should be carried out at a rate of about 1° C. to about 5° C. rise per hour to the final temperature. After baking, the carbonized stock may be impregnated one or more times with coal tar or petroleum pitch, or other types of pitches or resins known in the industry, to deposit additional coke in any open pores of the stock. Each impregnation is then followed by an additional baking step.

After baking, the carbonized stock is then graphitized. Graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C. At these high temperatures, elements other than carbon are volatilized and escape as vapors. The time required for maintenance at the graphitization temperature using the process of the present invention is no more than about 18 hours, indeed, no more than about 12 hours. Preferably, graphitization is for about 1.5 to about 8 hours. Once graphitization is completed, the finished article can be cut to size and then machined or otherwise formed into its final configuration.

In order to provide an electrode joint having improved stability in the furnace, the male tang, whether it be machined into the end of one of the electrodes or on a pin, (and, by extension, the female socket) must be dimensioned such that the tang will provide the required strength in use. In order to do so, a balancing must be accomplished. More particularly, it is now been discovered that the ratio of the length of the male tang to the diameter of the electrode (referred to herein as the tang factor) is important in optimizing the performance of an electrode joint, especially a male-female joint. More specifically, a tang factor of at least about 0.60 is believed to be important in creating an electrode joint having improved stability and commercially acceptable performance.

The interaction of other joint characteristics can also help optimize the electrode joint. For instance, a factor (referred to herein as the tang diameter factor) defined by the ratio of the diameter of the male tang at its base to the male tang length can be used to provide even further enhancements to the joint. The tang diameter factor should be no greater than 2.5 times the tang factor for an especially effective joint with a tang factor of about 0.60. Indeed, the tang diameter factor should most preferably vary with the tang factor, such that when a joint with a tang factor higher than 0.60 is produced, the tang diameter factor of the joint should be lower than 2.5 times the tang factor. More specifically, for every 0.01 higher than 0.60 that the tang factor of a joint is, the maximum tang diameter factor should be about 0.016 lower. As an example, when a joint having a tang factor of 0.85 is produced, the tang diameter factor of the male tang of the joint should be lower than about 1.28 times the tang factor of the joint.

Another joint characteristic that can come into play in designing an effective joint is referred to herein as the taper factor, which is defined as the ratio of the taper (expressed in degrees, and illustrated in FIG. 2 as the angle designated α) of the male tang to the tang factor. The taper factor for an effective joint should be at least about 15, where the tang factor is 0.85, and should also vary as joints with different tang factors are produced. For instance, for every 0.01 lower than 0.85 that the tang factor of a joint is, the minimum taper factor should be about 1.25 higher. As an example, when a joint having a tang factor of 0.60 is produced, the taper factor of the male tang of the joint should be at least about 45.

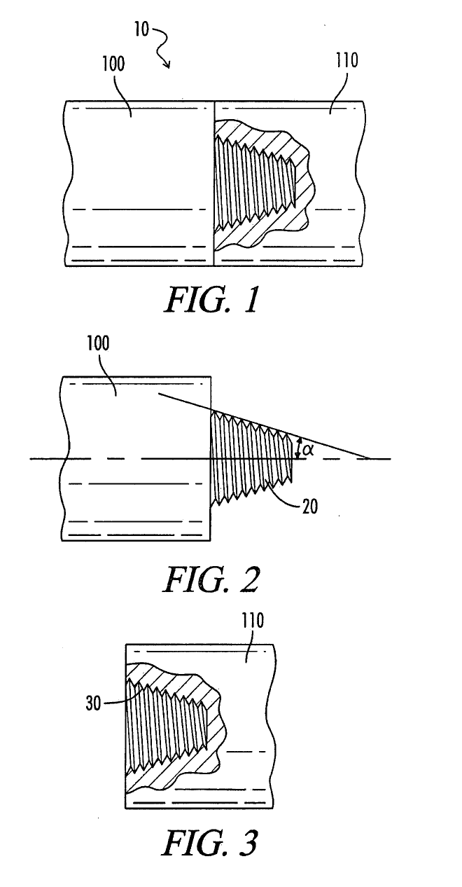

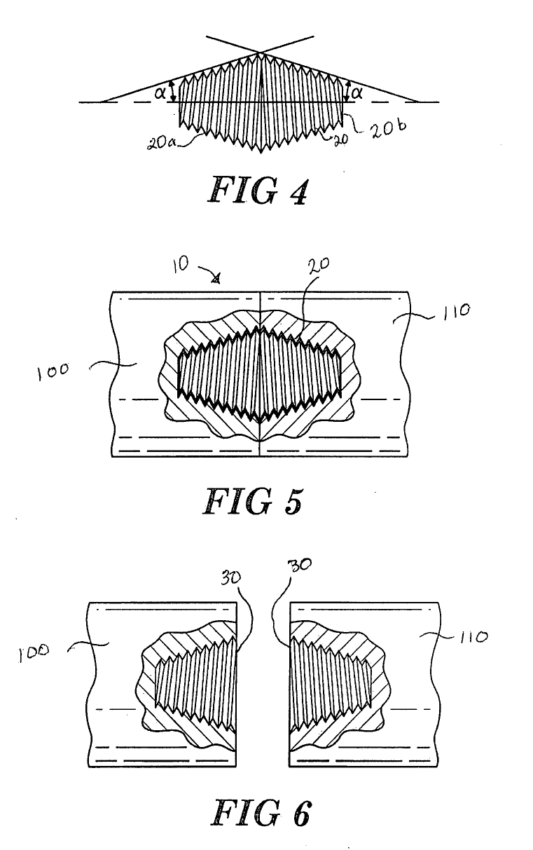

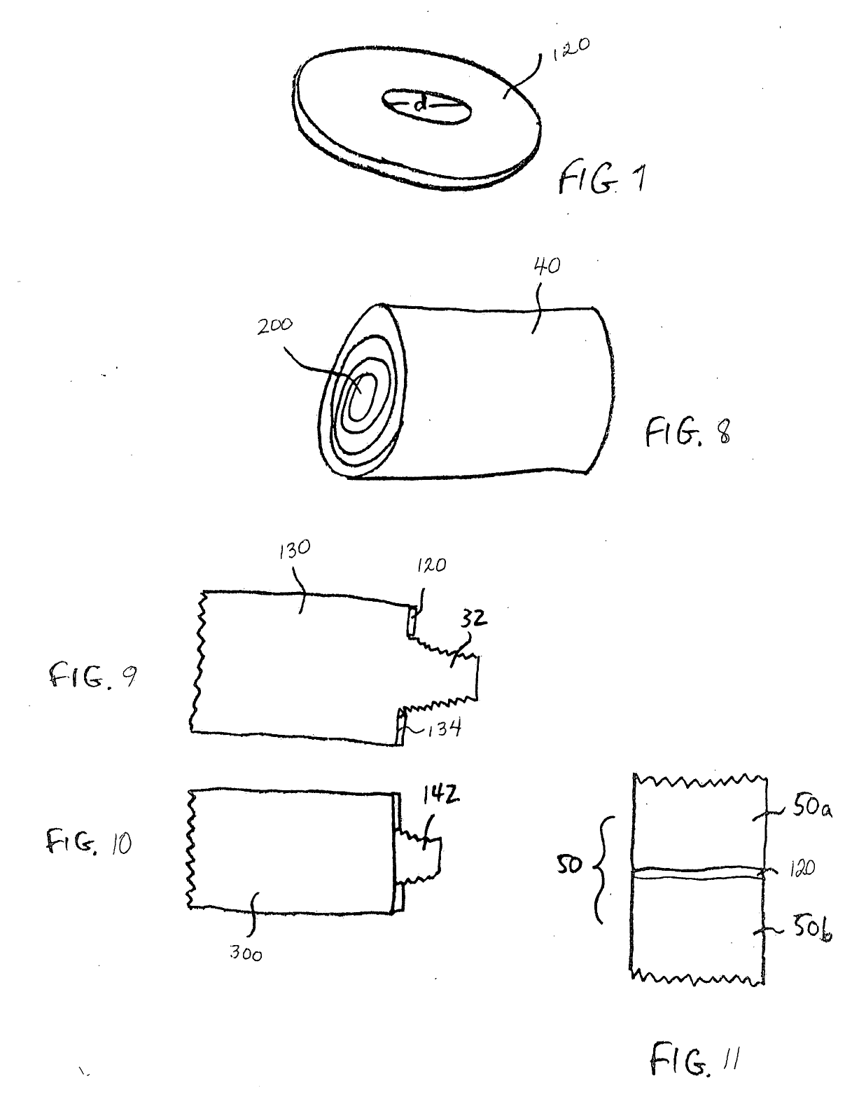

When employing the tang factor of at least about 0.60, and/or the tang diameter factor or taper factor of the joint as described above, a joint is produced that can achieve commercial acceptability, at least in terms of joint strength and stability. A typical graphite electrode joint produced in accordance with the invention is illustrated in FIGS. 1-6 and denoted 10. Joint 10 comprises a first electrode 100 and a second electrode 110, first electrode 100 having a male tang 20 and second electrode 110 having a female socket 30. As illustrated, male tang 20 and female socket 30 cooperate to form joint 10 and thus connect first electrode 100 and second electrode 110 into a column. With proper dimensioning of male tang 20 (and corresponding dimensioning of female socket 30), an improved joint 10 is provided.

It will be recognized by the skilled artisan that the optimized male tang described hereinabove will also apply to pin-joined graphite electrodes. In other words, in a pin-joined graphite electrode joint, as opposed to a male-female joint, the pin effectively has two male tangs, in the form of the two male sections of the pin. These male tangs can also be proportioned in the manner described above to optimize the functioning of a pin-joined joint, in a similar manner as the functioning of a male-female joint is optimized.

The pins used to connect graphite electrodes can be fabricated by first combining a particulate fraction comprising calcined coke, pitch and, optionally, mesophase pitch or PAN-based carbon fibers into a stock blend. More specifically, crushed, sized and milled calcined petroleum coke is mixed with a coal-tar pitch binder to form the blend. The particle size of the calcined coke is selected according to the end use of the article, and is within the skill in the art. Generally, particles up to about 25 millimeters (mm) in average diameter are employed in the blend. The particulate fraction preferable includes a small particle size filler comprising coke powder. Other additives that may be incorporated into the small particle size filler include iron oxides to inhibit puffing (caused by release of sulfur from its bond with carbon inside the coke particles), coke powder and oils or other lubricants to facilitate extrusion of the blend.

Most preferably, the carbon fibers (when used) are preferably present at a level of about 0.5 to about 6 parts by weight of carbon fibers per 100 parts by weight of calcined coke, or at about 0.4% to about 5.5% by weight of the total mix components (excluding binder). The preferred fibers have an average diameter of about 6 to about 15 microns, and a length of preferably about 4 mm to about 25 mm, and most preferably less than about 32 mm. The carbon fibers used in the inventive process should preferably have a tensile strength of at least about 150,000 psi. Most advantageously, the carbon fibers are added to the stock blend as bundles, each bundle containing from about 2000 to about 20,000 fibers.

Preferably, the fibers are added after mixing of the particulate fraction and pitch has already begun. Indeed, in a more preferred embodiment, the fibers are added after at least about half the mix cycle has been completed, most preferably after at least about three-quarters of the mix cycle has been completed. For instance, if the mixing of the particulate fraction and pitch takes two hours (i.e., a mix cycle is two hours), the fibers should be added after one hour, or even ninety minutes, of mixing. Adding the fibers after the mixing has begun will help preserve fiber length (which can be reduced during the mixing process) and thereby the beneficial effects of the inclusion of fibers, which are believed to be directly related to fiber length.

As noted above, the particulate fraction can include small particle size filler (small is used herein as compared to the particle size of the calcined coke, which generally has a diameter such that a major fraction of it passes through a 25 mm mesh screen but not a 0.25 mm mesh screen, and as compared to the fillers conventionally employed). More specifically, the small particle size filler comprises at least about 75% coke powder, by which is meant coke having a diameter such that at least about 70% and more advantageously up to about 90%, will pass through a 200 Tyler mesh screen, equivalent to 74 microns.

The small particle size filler can further comprise at least about 0.5% and up to about 25% of other additives like a puffing inhibitor such as iron oxide. Again, the additive should also be employed at a particle size smaller than that conventionally used. For instance, when iron oxide is included, the average diameter of the iron oxide particles should be such that they are smaller than about 10 microns. Another additional additive which can be employed is petroleum coke powder, having an average diameter such that they are smaller than about 10 microns, added to fill porosity of the article and thus enable better control of the amount of pitch binder used. The small particle size filler should comprise at least about 30%, and as high as about 50% or even 65% of the particulate fraction.

After the blend of particulate fraction, pitch binder, etc. is prepared, the body is formed (or shaped) by extrusion though a die or molded in conventional forming molds to form what is referred to as a green stock. The forming, whether through extrusion or molding, is conducted at a temperature close to the softening point of the pitch, usually about 100° C. or higher. The die or mold can form the article in substantially final form and size, although machining of the finished article is usually needed, at the very least to provide structure such as threads. The size of the green stock can vary; for electrodes the diameter can vary between about 220 mm and 700 mm.

After extrusion, the green stock is heat treated by baking at a temperature of between about 700° C. and about 1100° C., more preferably between about 800° C. and about 1000° C., to carbonize the pitch binder to solid pitch coke, to give the article permanency of form, high mechanical strength, good thermal conductivity, and comparatively low electrical resistance, and thus form a carbonized stock. The green stock is baked in the relative absence of air to avoid oxidation. Baking should be carried out at a rate of about 1° C. to about 5° C. rise per hour to the final temperature. After baking, the carbonized stock may be impregnated one or more times with coal tar or petroleum pitch, or other types of pitches or resins known in the industry, to deposit additional coke in any open pores of the stock. Each impregnation is then followed by an additional baking step.

After baking, the carbonized stock is then graphitized. Graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C. At these high temperatures, elements other than carbon are volatilized and escape as vapors. The time required for maintenance at the graphitization temperature using the process of the present invention is no more than about 18 hours, indeed, no more than about 12 hours. Preferably, graphitization is for about 1.5 to about 8 hours. Once graphitization is completed, the finished article can be cut to size and then machined or otherwise formed into its final configuration.

The inventive seal (or locking ring) used in the electrode joint of the present invention comprises a material that is disposed in an electrode joint between the end-faces of the adjoining electrodes. The seal preferably comprises a material sized so as to fill the gap between the adjoining electrodes. To that end, the seal should advantageously be between about 1 mm and about 25 mm in thickness, more advantageously, between about 3 mm and about 12 mm in thickness. In addition, the seal should extend radially from the perimeter of the electrode joint in towards the center of the joint, terminating between the perimeter and the threaded pin or male threaded tang. Most preferably, the radius of the seal should be approximately equal to that of the electrodes between which it is disposed. Thus, the inventive seal should have a radius of between about 220 mm and about 375 mm (when used with graphite electrodes having a circular cross-section), more preferably between about 200 mm and about 300 mm, with a central opening having a diameter approximately equal to or larger than the diameter of the threaded pin or male tang (at their respective largest point); more particularly, the diameter of the central opening of the seal should be between about 50% and about 85% of the diameter of the electrodes between which it is disposed. In the most preferred embodiment, the central opening of the seal should be approximately equal to the diameter of threaded pin or male tang (at their respective largest point).

The material(s) from which the inventive seal is produced or the orientation or placement of the seal, should be such that the seal is compressible to compensate for differences and changes in the gap between adjoining electrodes, which can vary based on the method used to connect the adjoining electrodes, as well as due to the different mechanical and thermal stresses to which the joint is exposed while in use in the furnace. In addition, compressibility of the seal material can help ensure that air does not pass between the seal and the electrodes between which it is positioned.

The material from which the seal of the present invention is formed should function to slow the rate at which the threads of the electrode joint oxidize. To do so, it has to reduce (or physically block) the exposure of the threads to the hot air in the furnace. More preferably, the seal material should oxidize at a rate equal to or slower than that of the electrodes forming the joint. Most preferably, the seal material should oxidize at as slow a rate as possible, while meeting the compressibility requirements.

Suitable materials useful for forming the inventive seal include paper, cardboard, paste, braided rope, etc. One especially preferred material is compressed particles of expanded (or exfoliated) graphite, sometimes referred to as flexible graphite. Especially useful are sheets of compressed particles of exfoliated graphite.

The graphite useful in forming the seals of the present invention is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes.

Graphite starting materials for the sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the flakes are intercalated, any excess solution is drained from the flakes and the flakes are water-washed.

Alternatively, the quantity of the intercalation solution may be limited to between about 10 and about 40 pph, which permits the washing step to be eliminated as taught and described in U.S. Patent No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalated graphite flake with the organic reducing agent, the blend can be exposed to temperatures in the range of 25° to 125° C. to promote reaction of the reducing agent and intercalated graphite flake. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The above described methods for intercalating and exfoliating graphite flake may beneficially be augmented by a pretreatment of the graphite flake at graphitization temperatures, i.e. temperatures in the range of about 3000° C. and above and by the inclusion in the intercalant of a lubricious additive, as described in International Patent Application No. PCT/US02/39749.

The pretreatment, or annealing, of the graphite flake results in significantly increased expansion (i.e., increase in expansion volume of up to 300% or greater) when the flake is subsequently subjected to intercalation and exfoliation. Indeed, desirably, the increase in expansion is at least about 50%, as compared to similar processing without the annealing step. The temperatures employed for the annealing step should not be significantly below 3000° C., because temperatures even 100° C. lower result in substantially reduced expansion.

The annealing of the present invention is performed for a period of time sufficient to result in a flake having an enhanced degree of expansion upon intercalation and subsequent exfoliation. Typically the time required will be 1 hour or more, preferably 1 to 3 hours and will most advantageously proceed in an inert environment. For maximum beneficial results, the annealed graphite flake will also be subjected to other processes known in the art to enhance the degree expansion—namely intercalation in the presence of an organic reducing agent, an intercalation aid such as an organic acid, and a surfactant wash following intercalation. Moreover, for maximum beneficial results, the intercalation step may be repeated.

The annealing step of the instant invention may be performed in an induction furnace or other such apparatus as is known and appreciated in the art of graphitization; for the temperatures here employed, which are in the range of 3000° C., are at the high end of the range encountered in graphitization processes.

Because it has been observed that the worms produced using graphite subjected to pre-intercalation annealing can sometimes “clump” together, which can negatively impact area weight uniformity, an additive that assists in the formation of “free flowing” worms is highly desirable. The addition of a lubricious additive to the intercalation solution facilitates the more uniform distribution of the worms across the bed of a compression apparatus (such as the bed of a calender station conventionally used for compressing (or “calendering”) graphite worms into flexible graphite sheet. The resulting sheet therefore has higher area weight uniformity and greater tensile strength, even when the starting graphite particles are smaller than conventionally used. The lubricious additive is preferably a long chain hydrocarbon. Other organic compounds having long chain hydrocarbon groups, even if other functional groups are present, can also be employed.

More preferably, the lubricious additive is an oil, with a mineral oil being most preferred, especially considering the fact that mineral oils are less prone to rancidity and odors, which can be an important consideration for long term storage. It will be noted that certain of the expansion aids detailed above also meet the definition of a lubricious additive. When these materials are used as the expansion aid, it may not be necessary to include a separate lubricious additive in the intercalant.

The lubricious additive is present in the intercalant in an amount of at least about 1.4 pph, more preferably at least about 1.8 pph. Although the upper limit of the inclusion of lubricous additive is not as critical as the lower limit, there does not appear to be any significant additional advantage to including the lubricious additive at a level of greater than about 4 pph.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compression molded together into flexible sheets having small transverse openings that, unlike the original graphite flakes, can be formed and cut into various shapes, as hereinafter described.

Alternatively, the flexible graphite sheets of the present invention may utilize particles of reground flexible graphite sheets rather than freshly expanded worms. The sheets may be newly formed sheet material, recycled sheet material, scrap sheet material, or any other suitable source.

Also the processes of the present invention may use a blend of virgin materials and recycled materials.

The source material for recycled materials may be sheets or trimmed portions of sheets that have been compression molded as described above, or sheets that have been compressed with, for example, pre-calendering rolls. Furthermore, the source material may be sheets or trimmed portions of sheets that have been impregnated with resin, but not yet cured, or sheets or trimmed portions of sheets that have been impregnated with resin and cured. The source material may also be recycled flexible graphite PEM fuel cell components such as flow field plates or electrodes. Each of the various sources of graphite may be used as is or blended with natural graphite flakes.

Once the source material of flexible graphite sheets is available, it can then be comminuted by known processes or devices, such as a jet mill, air mill, blender, etc. to produce particles. Preferably, a majority of the particles have a diameter such that they will pass through 20 U.S. mesh; more preferably a major portion (greater than about 20%, most preferably greater than about 50%) will not pass through 80 U.S. mesh. Most preferably the particles have a particle size of no greater than about 20 mesh.

The size of the comminuted particles may be chosen so as to balance machinability and formability of the graphite article with the thermal characteristics desired. Thus, smaller particles will result in a graphite article which is easier to machine and/or form, whereas larger particles will result in a graphite article having higher anisotropy, and, therefore, greater in-plane electrical and thermal conductivity.

If the source material has been resin impregnated, then preferably the resin is removed from the particles. Details of the resin removal are further described below.

Once the source material is comminuted, and any resin is removed, it is then re-expanded. The re-expansion may occur by using the intercalation and exfoliation process described above and those described in U.S. Pat. No. 3,404,061 to Shane et al. and U.S. Pat. No. 4,895,713 to Greinke et al.

Typically, after intercalation the particles are exfoliated by heating the intercalated particles in a furnace. During this exfoliation step, intercalated natural graphite flakes may be added to the recycled intercalated particles. Preferably, during the re-expansion step the particles are expanded to have a specific volume in the range of at least about 100 cc/g and up to about 350 cc/g or greater. Finally, after the re-expansion step, the re-expanded particles may be compressed into flexible sheets, as hereinbefore described.

Flexible graphite sheet and foil are coherent, with good handling strength, and are suitably compressed, e.g. by roll-pressing, to a thickness of about 0.075 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, fluoro-based polymers, or mixtures thereof Suitable epoxy resin systems include those based on diglycidyl ether or bisphenol A (DGEBA) and other multifunctional resin systems; phenolic resins that can be employed include resole and novolac phenolics. Optionally, the flexible graphite may be impregnated with fibers and/or salts in addition to the resin or in place of the resin.

The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

The thusly-formed flexible graphite sheet, formed so as to have the required central opening can be used as is, or it can be formed into a laminate of several such flexible graphite sheets (without or without an interlayer adhesive) and used as the inventive seal in that manner. For example, sheets of compressed particles of exfoliated graphite are overlaid, preferably with the use of an adhesive therebetween, and then trimmed to the desired size and shape if necessary.

In another embodiment, because of the anisotropic nature of sheets of compressed particles of expanded graphite, the graphite sheet seal can be oriented such that the “a” direction, that is the direction parallel to the major opposed surfaces of the sheet, is directionally arrayed between the end faces of the electrodes. In this way, the higher electrical conductivity of the material in the “a” direction will improve the conductivity across the joint, as opposed to the “c” direction.

One embodiment of the inventive seal is illustrated in FIG. 7 and designated by the reference character 120. Seal 120 comprises a spiral wound sheet of flexible graphite, and has its “a” direction through the thickness of seal 120, rather than along its surface. Seal 120 can be formed, for instance, by winding one or more flexible graphite sheets around a bolster 200 having a diameter equal to the desired diameter of the central opening “d” of seal 120. The sheets are wound around bolster 200 until a radius equal to the desired radius of seal 120 is achieved, resulting in a spiral wound flexible graphite cylinder 40, which can be sliced into individual seals 120 of the desired thickness (either through bolster 200 or after removal of bolster 200). In this way, the “a” direction of higher conductivity is arrayed through the thickness of seal 120. Optionally, an adhesive can be interposed between the windings of seal 120 in order to prevent the spiral-wound seal 120 from unwinding.

Seal 120 is positioned between the end faces of adjoining graphite electrodes forming an electrode joint. For example, as illustrated in FIG. 9, when a graphite electrode 130 having a machined male threaded tang 132 is employed, seal 120 can be placed on end face 134 of electrode 100 about tang 132. When electrode 100 is then mated with an adjoining electrode having a machined female socket (not shown), therefore, seal 120 is positioned between the end faces of the adjoining electrodes. The same holds true for electrode 300, illustrated in FIG. 10, which uses a pin 142 rather than having a tang machined into its end.

Advantageously, seal 120 is positioned on electrode 130 during preparation of electrode 130, either at the forming plant or at the furnace site but prior to being brought into position above the furnace for loading onto the electrode column to reduce the operational steps of forming the joint (which often takes place in a relatively hazardous environment). Likewise, when pin 142 is pre-set into electrode 300, seal 120 can be positioned on electrode 300 at the same time.

Accordingly, in use, electrode end-face seal 120 is positioned between the adjoining electrodes 50a and 50b in an electrode joint 50, as illustrated in FIG. 11. Since seal 120 is compressible and advantageously oxidizes at a rate equal to or slower than that of electrodes 50a and 50b, it reduces oxygen ingress into joint 50 between the end faces of electrodes 50a and 50b and thereby reduces or eliminates oxidation of the threaded portions of pin 132 or male tang 142, and/or other surfaces of joint 50, extending the life and functionality of joint 50.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. An assembly with a threaded connection, comprising:
an outer part made from ceramic, having an axially tapered internal thread, and having a diameter A;
an inner part made from ceramic, having an axially tapered external thread, and having an equator with a diameter B, and
the diameter B at the equator of the inner part amounting to between 80% and 110% of the diameter A of the outer part.

2. The assembly according to claim 1, wherein the inner part and the outer part are made from synthetically produced carbon or graphite.

3. The assembly according to claim 1, wherein the outer part is a carbon electrode with a socket and the internal thread formed therein, and the inner part is a carbon nipple with the external thread formed to mesh with the internal thread for connecting two the electrodes.

4. The assembly according to claim 1, wherein the internal and external threads enclose a taper angle E with a centerline of the inner and outer parts, respectively, of 18 to 35 degrees.

5. The assembly according to claim 1, wherein the internal and external threads have a lead D of 2 to 4 threads per inch.

6. The assembly according to claim 1, wherein the inner part has an axial length C, and a ratio of the axial length C to the diameter B is from 0.5 to 2.0.

7. The assembly according to claim 1, wherein the outer parts and the inner part a configured and dimensioned to preclude end-face contact between the outer parts, wherein the internal threads and the external threads are fully engaged and conduct electrical current flowing between the outer parts to pass through the inner part but not through the end faces of the outer parts.

8. An electrode column, comprising:
the assembly according to claim 1, wherein the plurality of outer parts are carbon electrodes and the inner part is a nipple screwing the carbon electrodes together to form the electrode column, and wherein the assembly forms a load-bearing connection that is substantially not susceptible to unscrewing and cracking.

9. An assembly with a threaded connection, comprising:
carbon electrodes having a machined threaded male surface at one end thereof and a threaded female surface at an opposite end thereof configured to receive a corresponding male end from an adjoining electrode;
wherein the male and female surfaces are configured with geometrical design parameters that preclude end-face contact between mutually adjoining electrodes, and the threads of the male and female surfaces are fully engaged to force all electrical current to pass therethrough and not through end faces of the electrodes.
